(19) United States
(12) Patent Application Publication
(10) Pub. No.: US 2019/0204433 A1
(43) Pub. Date: Jul. 4, 2019

(54) METHOD OF TRACKING TARGET BY USING 2D RADAR WITH SENSOR

(71) Applicant: VIETTEL GROUP, Ha Noi City (VN)

(72) Inventors: Tang Bao Ngoc BUI, Ha Noi City (VN); Tran Su LE, Ha Noi City (VN); Quang Bang NGUYEN, Ha Noi City (VN)

(73) Assignee: VIETTEL GROUP, Ha Noi City (VN)

(21) Appl. No.: 16/217,762

(22) Filed: Dec. 12, 2018

(30) Foreign Application Priority Data
Dec. 29, 2017 (VN) 1-2017-05383

(51) Int. Cl. G01S 13/86; G06T 7/292; G01S 13/72; G01S 13/58; G01S 7/42

(52) U.S. Cl. CPC G01S 13/86; G06T 7/292; G01S 7/42; G01S 13/589; G01S 13/723

(57) ABSTRACT

Embodiments of the present invention include the different methods for data fusion from multi dissimilar sensors to reduce the noise of the tracking the 3D target in Cartesian coordinates. Accuracy of this invention is precise and more stable than the conventional methods that use geometric calculations of 2D radars to track 3D targets. The results of this invention are using the same 3D radars in the tracking system. These methods are not only implemented in existing tracking centers, but also handle the tradeoff between the data transmission capacity at the command center and the computational speed of system. This invention performs the sequential steps: determining the dynamical motion model of target, state prediction and measurement update. Wherein, the variation of steps is shown in the embodiment of this invention by the following different approaches: selective measurement; parallel filtering; state vector fusion; feedback state vector fusion; measurement fusion state vector fusion.

### BACKGROUND OF THE INVENTION

The present invention relates to methods in the field of integrating data from multiple radars to archive the less noise tracking results of 3D targets. Specifically, the invention relates to tracking methods by using the fusion of 2D radar and passive sensors.

Determining the position of 3D targets, indicating the azimuth (the horizontal angle from the observer relative to a reference direction) and the slant range (their distance to the sensor) to the detected target but the altitude (height or elevation) of the target is eliminated. To track 3D targets using measurements from 2D radars, it naturally requires that the journey of an airplane is constant altitude, velocity or the height of the target is consistent. Due to the insufficient information of measurements and the performance of tracking is highly dependent on the accuracy of initial height. The estimation can be made by using a single 2D radar but the altitude estimation errors are not very precise. The reason is that the observability of the target states is inferior from a single radar. An height-parameterized extended Kalman filtering (HPEKF) algorithm which is activated by the Range-Parameterized EKF (RPEKF) used in the bearing-only tracking problem was introduced. This method divides the altitude interval of interest which is first partitioned into subintervals. Another approach for altitude estimation and 3-D tracking is using two 2-D radars with the assumption of constant velocity and altitude.

Until now, no tracking 3D target system existed which used the fusion data of 2D radars and bearing-only sensors (such as Electro-Optical, Infrared sensors) to track 3D targets. Another key point, the cost factor plays a substantial role and 2D radars are relatively cheap and efficient sensors compared with 3D radars. Under those circumstances, we present techniques to fuse data from 2D radars and passive sensors, although each of these sensors has its own limitations in spatial and temporal coverage.

### SUMMARY OF THE INVENTION

The purpose of the invention is to construct a system that can use different methods by using the fusion of 2D radar and bearing-only sensors to reduce the error of the tracking the 3D target in Cartesian coordinates. The accuracy of our invention is more precise and stable than the conventional methods that use only geometric calculations of 2D radars or only passive radars to track 3D targets. In addition, the results of our invention are equivalent to use of the 3D radars in the tracking system.

We propose in the invention six different methods to fuse data from multiple 2D radars and proposed directional sensors. These methods are adaptable to implement in the existing tracking centers (either locally, centrally, or both) as well as the tradeoff between the data transmission capacity at the command center and the computational speed of the system.

### BRIEF DESCRIPTION OF THE DRAWINGS

The following drawings will be used to more fully describe embodiments of the present invention.

FIG. 1 is a block diagram showing a general overview of the tracking system according to the prior art

FIG. 2 is a block diagram describing a selected measurement method according to an embodiment of the present invention

FIG. 3 is a block diagram describing a measurement fusion method according to an embodiment of the present invention

FIG. 4 is a block diagram illustrating a parallel filter method according to an embodiment of the present invention

FIG. 5 is a block diagram demonstrating a state vector fusion method according to an embodiment of the present invention

FIG. 6 is a block diagram depicting a feedback state vector fusion method according to an embodiment of the present invention

FIG. 7 is a block diagram interpreting a measurement fusion and state vector fusion method according to an embodiment of the present invention

FIGS. 8.1 and 8.2 are tables illustrating in further detail the root mean square errors of each 2D radar, bearing-only sensor and six different methods at time T=30 sec. and T=60 sec. according to an exemplary embodiment.

FIGS. 9.1 and 9.2 are figures explaining the absolute errors and root sum square errors at time T=30 sec. according to an exemplary embodiment.

FIGS. 10.1 and 10.2 are figures explaining the absolute errors and root sum square errors at time T=60 sec. according to an exemplary embodiment.

### DETAILED DESCRIPTION OF THE PREFERRED EMBODIMENT

The present invention relates to tracking a 3D target such as aircraft, car, or ship from multi-sensors. Among the various techniques available for Multi-sensor data fusion (MSDF), Extended Kalman Filtering-based approach is used for the present case, as it proves to be an efficient recursive algorithm suitable for real-time application and for a dynamical target which is tracked by bearing-only sensors is supposed have the nonlinear system model in Cartesian coordinates.

In our tracking 3D target system applying the data fusion technique for 2d radar and bearing-only sensor thus we have to reconstruct some of variation the Extended Kalman Filter (EKF) that one may fit six methods in our invention.

Let us briefly describe the main steps of general tracking system that use EKF algorithm as follow:

Step 1: Supposing the motion of target follows the dynamic nonlinear model as

\hat{x}=f(x,w) (1)

zⱼ=hⱼ(x,vⱼ), j=1, . . . , N (2)

where x is state of vector and we have N tracked sensors and radars, zⱼ is measurement vector, w and vⱼ are zero mean white Gauss noises with covariance matrix Q,Rⱼ.

Step 2: State prediction:

estimation state vector: \hat{x}_{k+1,k}^{j}=fₖ(\hat{x}_{k,k}^{j},0) (3)

state covariance matrix: P_{k+1,k}ⁱ=FₖP_{k,k}ⁱFₖ^{T}+Q (4)

Step 3: Measurement Update:

Gain: K_{k+1,j}=P_{k+1,k}^{j}H_{k+1,j}^{T}(H_{k+1,j}P_{k+1,k}^{j}H_{k+1,j}^{T}+Rⱼ)⁻¹ (5)

State: \hat{x}_{k+1,k+1}^{j}=\hat{x}_{k+1,k}^{j}+K_{k+1,j}(z_{k+1,j}−h_{k+1,j}(\hat{x}_{k+1,k}^{j},0)) (6)

State covariance: P_{k+1,k+1}^{j}=(I−K_{k+1,j}H_{k+1,j})P_{k+1,k}^{j},j=1, . . . , N. (7)

where Fₖ and H_{k,j} are corresponding Jacobi matrices of f and hⱼ at time step k when we carry out Taylor series expansion on these functions.

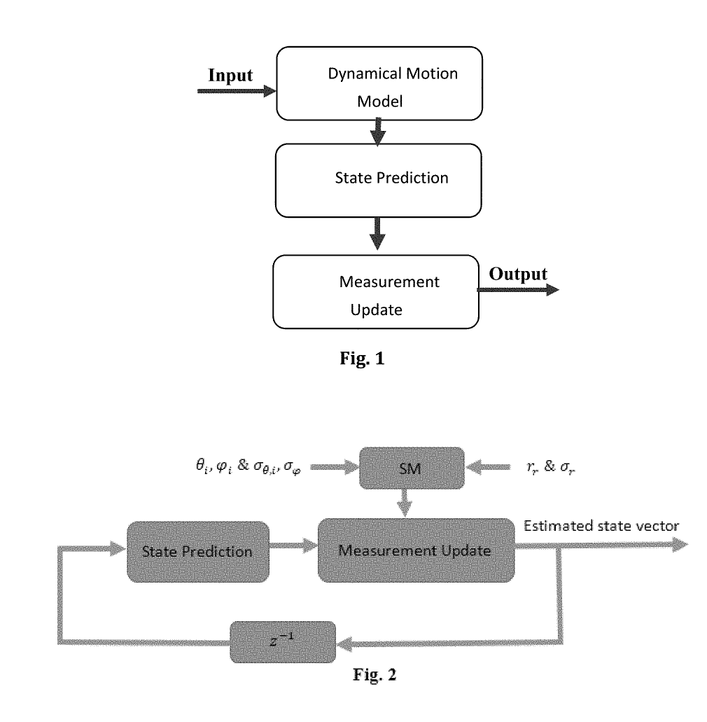

The block diagram is shown in FIG. 1.

We introduce here parameters that are input in our tracking system: zᵣ=[φᵣ rᵣ]^{T} and zᵢ=[θᵢ φᵢ]^{T}: are measurement vectors 2D radars and bearing-only sensors in polar coordinates, respectively. Where the sign r corresponds to radars and i corresponds to bearing-only sensors.

$${R}_{r} = [ \begin{matrix}{σ}_{r , r}^{2} & 0 \\ 0 & {σ}_{ϕ , r}^{2}\end{matrix} ] , {R}_{i} = [ \begin{matrix}{σ}_{θ , i}^{2} & 0 \\ 0 & {σ}_{ϕ , i}^{2}\end{matrix} ] \text{:}$$

: are the noise covariances corresponding to measurements.

The following formulae will use to transform from Cartesian coordinates to polar coordinates:

$$r = \sqrt{{x}^{2} + {y}^{2} + {z}^{2}} , ϕ = {tan}^{- 1} ( \frac{y}{x} ) , θ = {tan}^{- 1} ( \frac{z}{r} ) . \qquad ( 9 )$$

The Jacobi matrices and the variation of the models will be different depending on each method in the invention which will be described as follows:

### 1st Method: Selective Measurements (SM)

Step 1: The motion model

\hat{x}=f(x,w)

zₖ=[θᵢ φᵢ rᵣ]^{T}

In this method, the measurement vector in formula (3) will be replaced by the new measurement vector zₖ which consists of azimuth vector [rᵣ]^{T} of 2D radar measurements and measurement vector [θᵢ φᵢ]^{T} of bearing-only sensors.

Step 2: state prediction: Using the equation (3), (4)

Step 3: Measurement update: Using the same formulae (5), (6) and (7) with the new covariance Rₖ=diag[σ_{θ,i}² σ_{φi}² σ_{r,r}²] matrices: in formula (5) and the function h(x) in formulae (6)-(7) is slightly changed as:

$$h ( x ) = [ {tan}^{- 1} ( \frac{z}{r} ) , {tan}^{- 1} ( \frac{y}{x} ) , \sqrt{{x}^{2} + {y}^{2} + {z}^{2}} ]$$

The block diagram is shown in FIG. 2.

### 2^{nd} Method: Measurement Fusion (MF)

Step 1: The motion model:

\hat{x}=f(x,w), zₖ=[θᵢ φ_{f} rᵣ]^{T}

we fuse the azimuths [φᵣ]^{T}, [φᵢ]^{T} based on a minimum-mean-square-error criterion extracted from radar measurement and bearing-only. These ones accompanied with elevation of bearing-only sensor and range of 2D radar merged into an augmented measurement vector zₖ and measurement noise variances from both sensors are also concatenated to yield the similar process of the 1^{st} method.

Step 2: state prediction: Using the equation (3), (4)

Step 3: Measurement update: Using the same formulae (5), (6) and (7) with just the new covariance matrices: Rₖ=diag[σ_{θ,i}² σ_{φ,f}² σ_{r,r}²] in formula (5).

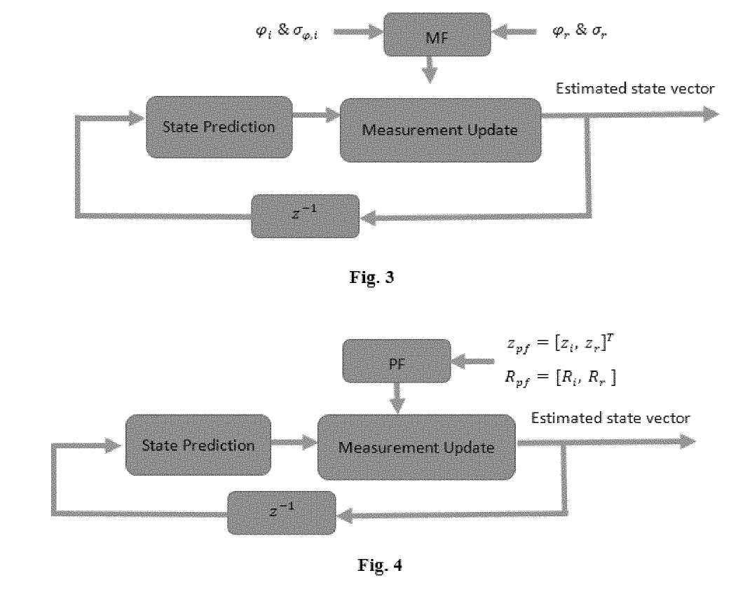

The block diagram is shown in FIG. 3.

### 3^{rd} Method: Parallel Filter (PF)

Step 1: The motion model:

\hat{x}=f(x,w), zₖ=[θᵢ φᵢ φᵣ rᵣ]^{T}

All measurement vectors can be fused into a new form of measurement vector zₖ by combination of 2D measurement vectors zᵣ=[φᵣ rᵣ]^{T}, and bearing-only measurement vector zᵢ=[θᵢ φᵢ]^{T}

Step 2: state prediction: Using the equation (3), (4)

Step 3: Measurement update: Using the same formulae (5), (6) and (7) with the new covariance matrices: Rₖ=diag[σ_{θ,i} σ_{φ,i}² σ_{φ,r}² σ_{r,r}²], and the function h(x) in formulae (6)-(7) is slightly changed as: hₖ=[hᵢ hᵣ]^{T}.

The block diagram is shown in FIG. 4.

### 4^{th} Method: State Vector Fusion (SVF)

Step 1: Performing the step 1, 2 and 3 of general tracking system in FIG. 1 for the 2d radars at local center to achieve the estimate state vector and the covariance matrices at local center

\hat{x}_{k+1,k+1}^{r}=\hat{x}_{k+1,k}^{r}+K_{k+1,j}(z_{k+1,j}−h_{k+1,j}(\hat{x}_{k+1,k}^{r},0))

P_{k+1,k+1}^{r}=(I−K_{k+1,j}H_{k+1,j})P_{k+1,k}^{r},

Step 2: Performing the step 1, 2 and 3 of general tracking system in FIG. 1 for the bearing-only sensors at the local center to achieve the estimate state vector and the covariance matrices at local center

\hat{x}_{k+1,k+1}ⁱ=\hat{x}_{k+1,k}ⁱ+K_{k+1,j}(z_{k+1,j}−h_{k+1,j}(\hat{x}_{k+1,k}ⁱ,0))

P_{k+1,k+1}ⁱ=(I−K_{k+1,j}H_{k+1,j})P_{k+1,k}ⁱ,

Step 3: Performing data fusion of the local estimate state vectors at step 2 in this method, based on a minimum-mean-square-error criterion to yield a fused state vectors \hat{x}_{f}, P_{f} at command center.

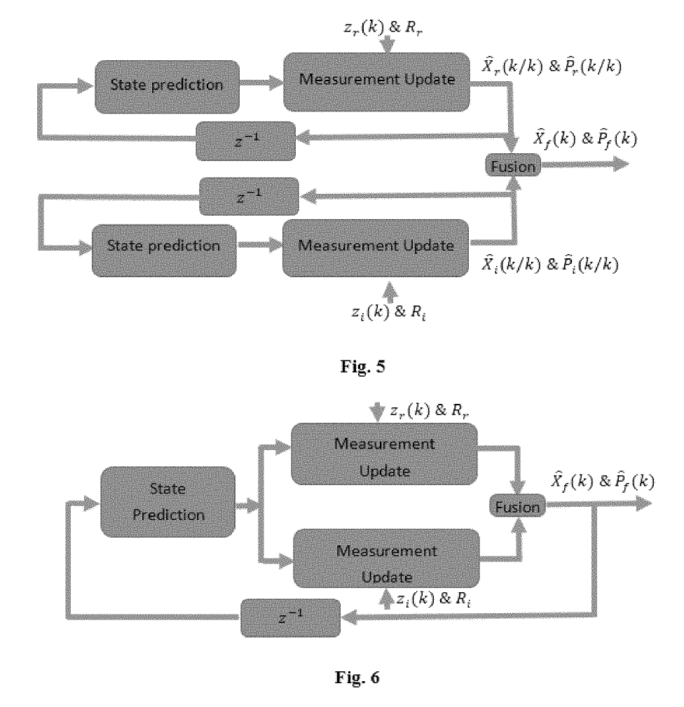

The block diagram is shown in FIG. 5.

### 5^{th} Method: Feedback State Vector Fusion (FSVF)

Step 1: Performing the step 1, 2 and 3 in method 4 to achieve the fused estimate state vector and the fused covariance matrices \hat{x}_{k,k}^{f}, P_{k,k}^{f} at a command center

Step 2: The fused state vector and fused state covariance matrix are fed back to a single state predictor of step 1 and the output of this process fed to two measurement update

State prediction: \hat{x}_{k+1,k}=Fₖ\hat{x}_{k,k}^{f}

Covariance prediction: P_{k+1,k}=FₖP_{k,k}^{f}Fₖ^{T}+Q

The block diagram is shown in FIG. 6.

### 6^{th} Method: Measurement Fusion State Vector Fusion (MFSVF)

Step 1: Performing the step 1, 2 of general tracking system in FIG. 1 for the 2d radars at local center to achieve the predicted state vectors and the covariance matrices \hat{x}_{k+1,k}^{r},P_{k+1,k}^{r} at local center.

Step 2: Performing the step 1, 2 of general tracking system in FIG. 1 for the bearing-only sensors at local center to achieve the predicted state vectors and the covariance matrices \hat{x}_{k+1,k}^{r},P_{k+1,k}^{r} at local center.

Step 3: Performing the first fusion of these locally predicted state vectors in Steps 1 and 2 of this method based on minimum-mean-square-error criterion to obtain (at the local center) a fused predict-state vectors \hat{x}_{k+1,k}^{f},P_{k+1,k}^{f}

Step 4: These fused predict-state vectors are fed to two measurement update at step 3 (measurement update) of general tracking system for 2D radars and bearing-only sensors at local center to obtain (at local center) an estimated state vectors and a corresponding covariance matrices: \hat{x}_{k+1,k+1}^{r},\hat{x}_{k+1,k+1}ⁱ,P_{k+1,k+1}^{r},P_{k+1,k+1}ⁱ,

Step 5: Performing the 2nd fusion of theses estimated state vectors at step 4 of this method based on minimum-mean-square-error criterion to yield a fused state-estimate vectors \hat{x}_{k+1,k+1}^{f},P_{k+1,k+1}^{f} at command center.

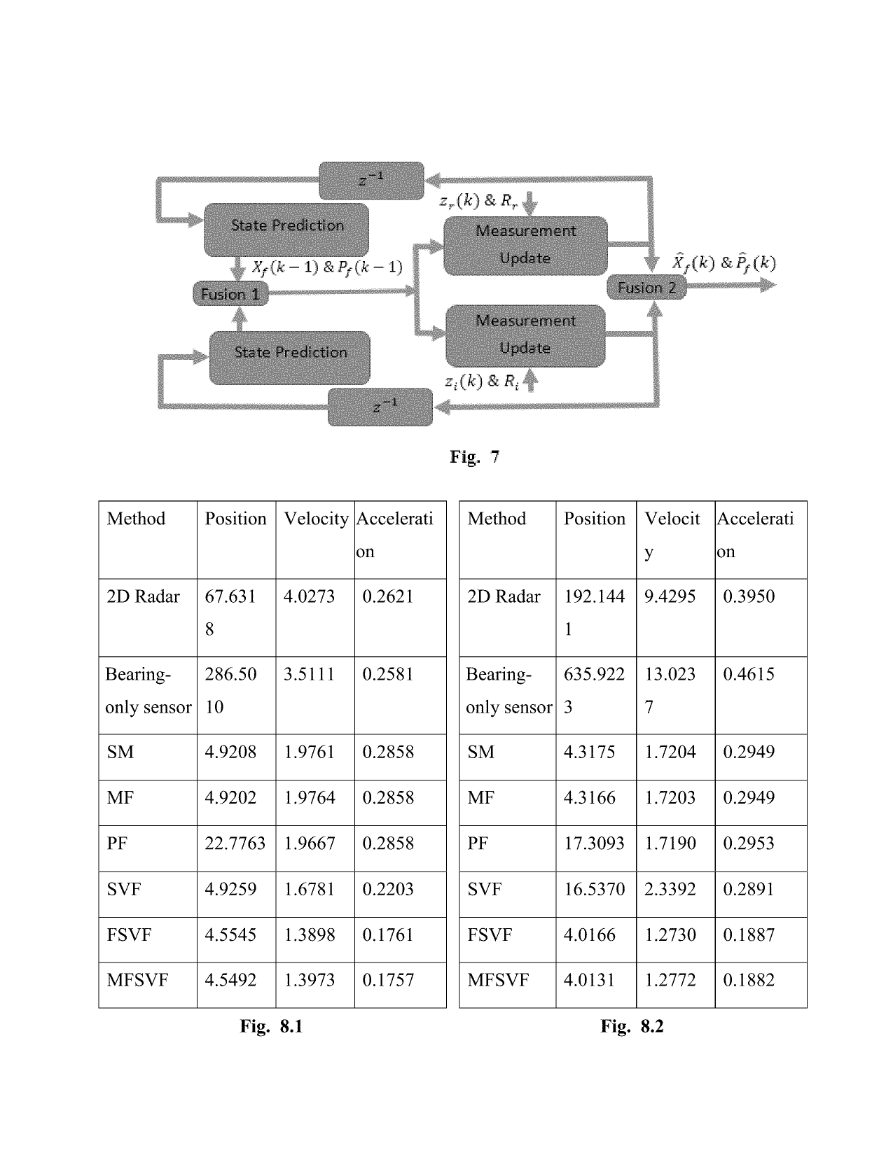

The block diagram is shown in FIG. 7.

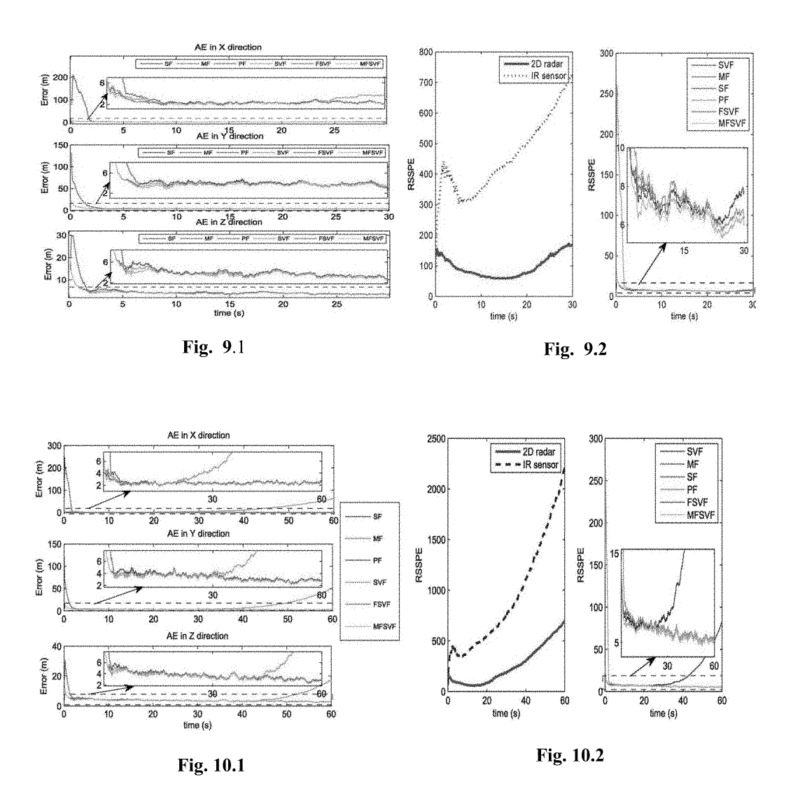

To evaluate results we run two hundred Monte Carlo simulation for two steps of time, T=30 sec. and T=60 sec. and use then the root mean square error (RMSE) in position, velocity and acceleration which are shown in in FIG. 8.1 and FIG. 8.2. The root sum square error (RSSE) in position which are illustrated in figure FIG. 9.2 for the time T1=30 sec. and in figure FIG. 10.2 for the time T2=60 sec. Absolute error (AE) in x, y, z direction which are depicted in FIG. 9.1 and FIG. 10.1. It can conclude that all errors of six methods are tremendously smaller 92.5% to 97.6% than errors which were provided 2D radar or 98.3% to 99.35 to IR sensor through the RMSE. As a side note, the results of SF, MF, FSVF and MFSVF method are equivalent and it is worth mentioning here that, PF and SVF method are slightly worse than the others with the tendency of error in PF method to get smaller as the time gets larger while the SVF method is opposite. This is explained by the error of PF method is very high at initial time step which quickly descends and tends to other methods whereas the error of SVF method is stable in a short time from initial time and ascends fast later.

What is claimed is:

1. A tracking 3D target system using fusion of 2D radars and bearing-only sensors includes the following steps:
STEP 1: determining the dynamical motion model of target; using equation:
\hat{x}=f(x,w) (1)
zₖ=[θᵢ φᵢ rᵣ]^{T}, (2), wherein include:
determining the state of vector x by tracked radars and sensors, and
determining is white Gauss noises with w and vⱼ are zero mean;
STEP 2: state prediction, wherein include:
determining covariance matrix Q, Rⱼ in respective;
determining estimation state: \hat{x}_{k+1,k}^{j}=fₖ(\hat{x}_{k,k}^{j},0) (3)
covariancing the estimation: P_{k+1,k}ⁱ=FₖP_{k,k}ⁱFₖ^{T}+Q (4)
STEP 3: measurement update:
determining coefficient of Gain: K_{k+1,j}=P_{k+1,k}^{j}H_{k+1,j}^{T}(H_{k+1,j}P_{k+1,k}^{j}H_{k+1,j}^{T}+Rⱼ)⁻¹ (5);
determining coefficient of State: \hat{x}_{k+1,k+1}^{j}=\hat{x}_{k+1,k}^{j}+K_{k+1,j}(z_{k+1,j}−h_{k+1,j}(\hat{x}_{k+1,k}^{j},0)) (6);
determining coefficient of State covariance: P_{k+1,k+1}ⁱ=(I−K_{k+1,j}H_{k+1,j})P_{k+1,k}^{j},j=1, . . . , N. (7).

2. A tracking 3D target system using fusion of 2D radars and bearing-only sensors of claim 1, wherein the selective measurement from dissimilar multi-sources 2D radars and bearing-only sensors includes the following steps:
step 1: determining the dynamical motion model of target:
\hat{x}=f(x,w)
zₖ=[θᵢ φᵢ rᵣ]^{T}
wherein the dynamical motion model of target include the following step:
establish a new measurement vector zₖ by selecting from the amount of 2D radar measurements and measurement vector [θᵢ φᵢ]^{T} of bearing-only sensors which could be replaced the measurement vector directly selected from the equation:
zⱼ=hⱼ(x,vⱼ), j=1, . . . , N
step 2: state prediction: Using the equation (3), (4)
step 3: measurement update: using equation (5) wherein include the following step:
establishing new covariance matrices: Rₖ=diag[σ_{θ,i}² σ_{φ,i}² σ_{r,r}²];
establishing new equation (6) and (7) with Jacobi matrix in accordance with new measurement function:
$$h ( x ) = [ {tan}^{- 1} ( \frac{z}{r} ) , {tan}^{- 1} ( \frac{y}{x} ) , \sqrt{{x}^{2} + {y}^{2} + {z}^{2}} ] .$$

3. A tracking 3D target system using fusion of 2D radars and bearing-only sensors of claim 1, wherein the measurement fusion method executes for 2D radars and bearing-only sensors includes the following steps:
step 1: determining the dynamical motion model of target:
\hat{x}=f(x,w), zₖ=[θᵢ φ_{f} rᵣ]^{T}, wherein include:
fuse the azimuths from measurement vector of 2D radar: [φᵣ]^{T},
fuse the azimuths from measurement vector of tracked sensor: [φᵢ]^{T},
combined the azimuths from measurement vector of 2D radar [φᵣ]^{T} and azimuths from measurement vector of tracked sensor [φᵢ]^{T} based on a minimum-mean-square-error criterion extract,
these ones are accompanied with elevation of bearing-only sensor and range of 2D radar merged into an augmented measurement vector zₖ,
step 2: state prediction: using the equation (3), (4)
step 3: measurement update: using the equation (5) with just the new covariance matrices: Rₖ=diag[σ_{θ,i}² σ_{φ,f}² σ_{r,r}²].

4. A tracking 3D target system using fusion of 2D radars and bearing-only sensors of claim 1, wherein the parallel filter method executes for 2D radars and bearing-only sensors includes the following steps
step 1: determining the dynamical motion model of target:
\hat{x}=f(x,w), zₖ=[θᵢ φ_{f} rᵣ]^{T}, wherein include the following step:
all measurement vectors can be fused into a new form of measurement vector zₖ by combination of 2D measurement vectors zᵣ=[φᵣ rᵣ]^{T}, and bearing-only measurement vector zᵢ=[θᵢ φᵢ]^{T};
step 2: state prediction : using the equation (3), (4);
step 3: measurement update: using the equation (5), wherein include:
establish the new covariance matrices Rₖ=diag[σ_{θ,i}² σ_{φ,i}² θ_{φ,r}² θ_{r,r}²] and
establish new equation (6) and (7) with Jacobi matrices in accordance with a new measurement function: hₖ=[hᵢ hᵣ]^{T}.

5. A tracking 3D target system using fusion of 2D radars and bearing-only sensors of claim 1, wherein the state vector fusion method executes for 2D radars and bearing-only sensors includes the following steps:
step 1: performing the step 1, 2 and 3 of general tracking system in claim 1 for the 2D radars at a local center to achieve the estimate state vector and the covariance matrices at the local center;
\hat{x}_{k+1,k+1}^{r}=\hat{x}_{k+1,k}^{r}+K_{k+1,j}(z_{k+1,j}−h_{k+1,j}(\hat{x}_{k+1,k}^{r},0));
P_{k+1,k+1}^{r}=(I−K_{k+1,j}H_{k+1,j})P_{k+1,k}^{r};
step 2: performing the step 1, 2 and 3 of general tracking system in claim 1 for the bearing-only sensors at the local center to achieve the estimate state vector and the covariance matrices at local center;
\hat{x}_{k+1,k+1}ⁱ=\hat{x}_{k+1,k}ⁱ+K_{k+1,j}(z_{k+1,j}−h_{k+1,j}(\hat{x}_{k+1,k}ⁱ,0));
P_{k+1,k+1}ⁱ=(I−K_{k+1,j}H_{k+1,j})P_{k+1,k}ⁱ;
step 3: performing data fusion of the local estimate state vectors at step 2 in this method based on a minimum-mean-square-error criterion to yield a fused state vectors \hat{x}_{f}, P_{f} at a command center.

6. A tracking 3D target system using fusion of 2D radars and bearing-only sensors of claim 1, wherein the feedback state vector fusion method executes for 2D radars and bearing-only sensors includes the following steps:
step 1: performing the step 1, 2 and 3 in claim 5 to achieve the fused estimate state vector and the fused covariance matrices \hat{x}_{k,k}^{f},P_{k,k}^{f} at a command center;
step 2: the fused state vector and fused state covariance matrix are fed back to a single state predictor of step 1 and the output of this process fed to two measurement update:
state prediction: \hat{x}_{k+1,k}=Fₖ\hat{x}_{k,k}^{f} (3);
covariance P_{k+1,k}=FₖP_{k,k}^{f}Fₖ^{T}+Q prediction: (4).

7. A tracking 3D target system using fusion of 2D radars and bearing-only sensors of claim 1, wherein the measurement fusion state vector fusion method executes for 2D radars and bearing-only sensors includes the following steps:
step 1: performing the step 1, 2 of general tracking system in FIG. 1 for the 2d radars at local center to achieve the predicted state vectors and the covariance matrices \hat{x}_{k+1,k}^{r},P_{k+1,k}^{r} at a local center;
step 2: performing the step 1, 2 of general tracking system in FIG. 1 for the bearing-only sensors at the local center to achieve the predicted state vectors and the covariance matrices \hat{x}_{k+1,k}^{r},P_{k+1,k}^{r} at local center;
step 3: performing the first fusion of these locally predicted state vectors in Steps 1 and 2 of this method based on minimum-mean-square-error criterion to obtain a fused predict-state vectors \hat{x}_{k+1,k}^{f},P_{k+1,k}^{f} at the local center;
step 4: these fused predict-state vectors are fed to two measurement update at step 3 (measurement update) of general tracking system for 2D radars and bearing-only sensors at local center to obtain an estimated state vectors and a corresponding covariance matrices: \hat{x}_{k+1,k+1}^{r},\hat{x}_{k+1,k+1}ⁱ,P_{k+1,k+1}^{r},P_{k+1,k+1}ⁱ at local center;
step 5: performing the 2nd fusion of theses estimated state vectors at step 4 of this method based on minimum-mean-square-error criterion to yield a fused state-estimate vectors \hat{x}_{k+1,k+1}^{f},P_{k+1,k+1}^{f} at a command center.
